(19) United States
(12) Patent Application Publication
(10) Pub. No.: US 2024/0330803 A1
(43) Pub. Date: Oct. 3, 2024

(54) HIERARCHAL SCHEDULING FOR MULTIPLE SITE BUILDING MANAGEMENT SYSTEM

(71) Applicant: Honeywell International Inc., Charlotte, NC (US)

(72) Inventors: NITHIN YADALLA RAMGOPAL, Bangalore (IN); GUTHA STALIN SANGHAMITRA, Bangalore (IN); NITISH CHOPRA, Janakpuri (IN); SHREYA RATAKONDA, Hyderabad (IN)

(21) Appl. No.: 18/741,001

(22) Filed: Jun. 12, 2024

Related U.S. Application Data
(63) Continuation of application No. 17/346,177, filed on Jun. 11, 2021.
(60) Provisional application No. 63/039,381, filed on Jun. 15, 2020.

(51) Int. Cl. G06Q 10/0631

(52) U.S. Cl. CPC G06Q 10/06312; G06Q 10/063116; G06Q 10/06314; G06Q 10/06315

(57) ABSTRACT

One or more screens are displayed that allow a portfolio level user to create one or more portfolio level equipment schedules that are distributed from a multi-site BMS to one or more controllers at remote sites, which are configured to control operation of corresponding equipment at the remote sites in accordance with the portfolio level equipment schedules. A site level user is allowed to change a portfolio level equipment schedule and apply the changed portfolio level equipment schedule to one or more of the controllers of a remote site, resulting in an changed portfolio level equipment schedule. The portfolio level user is allowed to override the changed portfolio level equipment schedule at the first remote site and return to the portfolio level equipment schedule.

This is a continuation of co-pending U.S. patent application Ser. No. 17/346,177, filed Jun. 11, 2021, and entitled “HIERARCHAL SCHEDULING FOR MULTIPLE SITE BUILDING MANAGEMENT SYSTEM”, which claims the benefit of U.S. Provisional Application No. 63/039,381, filed Jun. 15, 2020, both of which are hereby incorporated by reference.

### TECHNICAL FIELD

The present disclosure relates generally to building management systems, and more particularly to multi-site building management systems.

### BACKGROUND

Portfolio managers may be responsible for monitoring tens, hundreds or even thousands of different building locations that may be spread out across different states or even across different nations. Each of the building locations have one or more schedules that dictate when and/or under what operating conditions (e.g. set points) various equipment operates. Maintaining multiple schedules for hundreds or even thousands of different locations, with multiple types of equipment at each location, can be daunting. What would be desirable is a multi-site management system that provides a hierarchal scheduling system that improves monitoring and control of the various building locations.

### SUMMARY

The present disclosure relates generally to helping a portfolio manager create and maintain equipment schedules for a variety of different types of equipment at a number of different building locations. In an example, a method manages equipment schedules for equipment that is distributed among a plurality of remote sites that are monitored by a multi-site Building Management System (BMS). One or more screens are displayed that allow a portfolio level user to create one or more portfolio level equipment schedules. The portfolio level equipment schedules are distributed from the multi-site BMS to one or more controllers at the remote sites. The one or more controllers are configured to control operation of corresponding equipment at the remote sites in accordance with the portfolio level equipment schedules. A site level user of a first remote site is allowed to change a portfolio level equipment schedule received from the multi-site BMS and apply the changed portfolio level equipment schedule to one or more of the controllers of the first remote site, resulting in a changed portfolio level equipment schedule. Additionally or alternatively, a site level user can locally create a new schedule that overrides the portfolio level equipment schedule. The one or more controllers at the first remote site to which the changed portfolio level equipment schedule was applied are configured to control operation of corresponding equipment at the first remote site in accordance with the changed portfolio level equipment schedule. The portfolio level user is allowed to override the changed portfolio level equipment schedule at the first remote site and return to the portfolio level equipment schedule.

In another example, a method monitors adherence with an equipment schedule for equipment distributed among a plurality of remote sites. A portfolio level calendar is created at a portfolio level that provides equipment schedules. A site level calendar at each of the plurality of remote sites is originally provided as a copy of the portfolio level calendar. One or more screens are displayed that allow a portfolio level user to selectively display either the portfolio level calendar or the site level calendar corresponding to one or more of the plurality of remote sites. One or more screens are displayed that allow the portfolio level user to selectively indicate either that the portfolio level calendar is to override a site level calendar that was customized at a site level or that the site level calendar customized at the site level is to override the portfolio level calendar. Instructions are provided as to whether the equipment at the site level is to operate in accordance with the portfolio level calendar or the site level calendar.

In another example, a method creates equipment schedules for equipment that is distributed at a plurality of remote locations. One or more screens are displayed that allow a user at a supervisory level (e.g. portfolio level) to create one or more master equipment schedules. The master equipment schedules are saved in a cloud-based server. The master equipment schedules from the cloud-based server are provided to one or more controllers at one or more of the remote locations. The one or more controllers at the one or more remote locations are configured to control operation of equipment at the one or more remote locations in accordance with the master equipment schedules. In some cases, one or more of the master equipment schedules are saved at the one or more remote locations as local equipment schedules. The equipment at the one or more remote locations is operated in accordance with the local equipment schedules. Someone responsible for a remote location is allowed to customize one or more of the local equipment schedules for that remote location, resulting in one or more customized local equipment schedules. This customization may be reported to the supervisory level. Someone at the supervisory level is allowed to override one or more of the customized local equipment schedules and return to one or more non-customized local equipment schedule if desired.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative building system including a multi-site BMS and a number of local sites;

FIG. 2 is a flow diagram showing an illustrative method of managing equipment schedules;

FIG. 3 is a flow diagram showing an illustrative method of monitoring adherence with a portfolio level equipment schedule;

FIG. 4 is a flow diagram showing an illustrative method of creating equipment schedules; and

FIGS. 5 through 27 show illustrative screens of a multi-site BMS for creating and monitoring equipment schedules.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

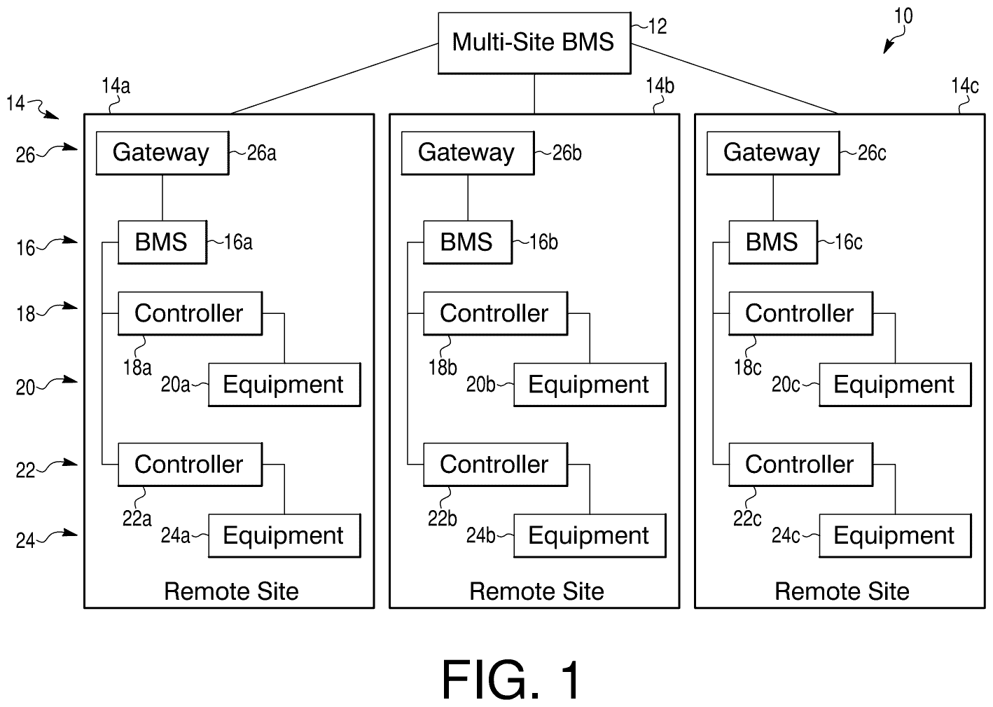

FIG. 1 is a schematic block diagram of an illustrative system 10. In its broadest terms, the illustrative system 10 includes a multi-site BMS 12 and a plurality of remote sites 14. At least parts of the multi-site BMS 12 may be manifested on a cloud-based server, or may store data within a cloud-based server. While a total of three remote sites 14 are shown, it will be appreciated that this is merely illustrative, as the multi-site BMS 12 may oversee and/or monitor operations at a large number of remote sites 14. In some cases, the multi-site BMS 12 may create equipment calendars at a portfolio level, and may provide these equipment calendars to each of the remote sites 14. The multi-site BMS 12 may also monitor adherence to the equipment schedules provided by the multi-site BMS 12. The remote sites 14 may be distributed across a large geographic area. Each of the remote sites 14 are individually labeled as 14a, 14b, 14c and may each represent any of a variety of different types of sites. While each of the remote sites 14 may be described herein as being buildings, this is not required in all cases. For example, some of the remote sites 14 may also represent factories or other processing facilities.

Each of the remote sites 14 include a BMS 16, individually labeled as 16a, 16b, 16c. Each BMS 16 may be considered as being operably coupled with a number of controllers 18 and 22. The controllers 18 are individually labeled as 18a, 18b, 18c while the controllers 22 are individually labeled as 22a, 22b, 22c. The controllers 18 may be considered as controlling operation of equipment 20, individually labeled as 20a, 20b, 20c while the controllers 22 may be considered as controlling operation of equipment 24, individually labeled as 24a, 24b, 24c.

It will be appreciated that there will typically be many more pieces of equipment 20, 24 than the two that are illustrated at each remote site 14. The equipment 20, 24 may include Heating, Ventilating and Air Conditioning (HVAC) system components. The equipment 20, 24 may include lighting system components such as indoor lighting equipment and/or outdoor lighting equipment, security system components, and the like. Each BMS 16 may be configured to receive operational data from the equipment 20, 24 via the controllers 18, 22 and to formulate control commands for the equipment 20, 24 in response to the received operational data and in accordance with an equipment calendar. In some cases, the equipment 20, 24 may be equipment that can be controlled in a binary fashion, i.e., the equipment 20, 24 is either on or off.

In some cases, the BMS 16 may be configured to provide operational data to the multi-site BMS 12. In order to communicate with the multi-site BMS 12, in some cases each of the remote sites 14 may include a gateway 26, individually labeled as 26a, 26b, 26c. The gateways 26, if present, may provide a way by which each BMS 16 can communicate with the multi-site BMS 12. The gateways 26 may provide a means for operational data to be uploaded from each BMS 16 to the multi-site BMS 12 as well as control commands to be downloaded from the multi-site BMS 12 to each BMS 16. In some cases, the gateways 26 may be configured to download software packages from the multi-site BMS 12 that better configures each BMS 16 for communication with the multi-site BMS 12.

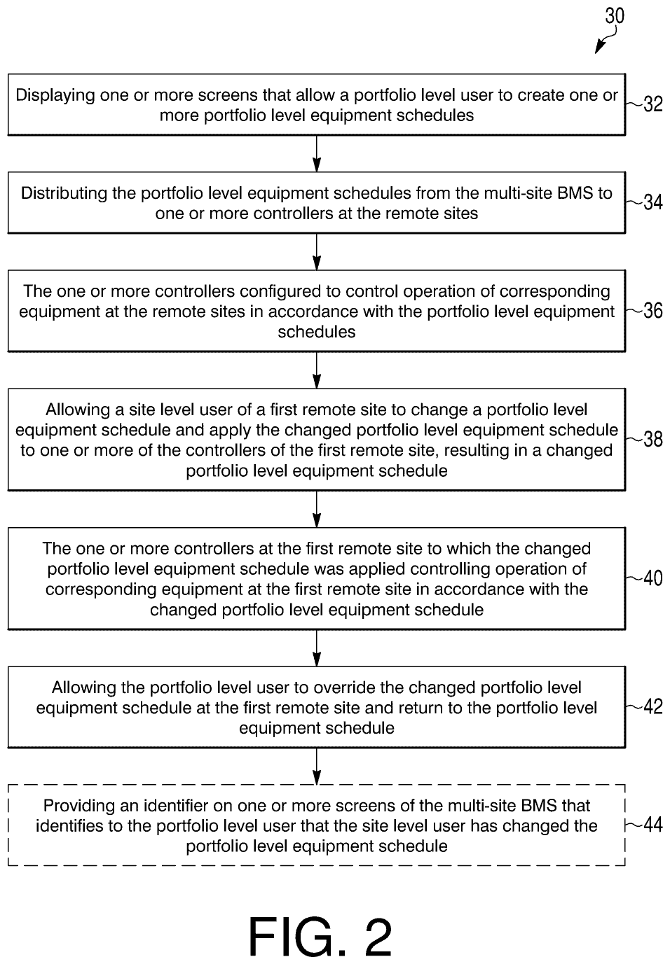

FIG. 2 is a flow diagram showing a method of managing equipment schedules for equipment 18, 20 that is distributed among a plurality of remote sites 14 that are monitored by the multi-site BMS 12. One or more screens are displayed that allow a portfolio level user to create one or more portfolio level equipment schedules, as indicated at block 32. In some cases, one or more of the portfolio level equipment schedules being at a time that is in the future relative to when the corresponding portfolio level equipment schedules were created. In some instances, a portfolio level user is able to create multiple schedules having differing start dates and/or differing end dates. In some cases, the portfolio level equipment schedules may, for example, include equipment ON times and equipment OFF times. In some cases, the portfolio level equipment schedules may, for example, include equipment set point schedules (e.g. comfort time period and energy saving time periods). These are just some examples. At least some of the portfolio level equipment schedules may include weekly schedules. The portfolio level equipment schedules may also include holiday schedules and/or special event schedules, for example.

In some instances, displaying one or more screens that allow the portfolio level user to create one or more portfolio level equipment schedules includes displaying a screen that includes one or more days and allows the portfolio level user to interact with the screen to create, for example, the equipment ON times and the equipment OFF times. Interacting with the screen may, for example, include grabbing an equipment ON time icon and/or an equipment OFF time icon and moving the icon on the calendar to adjust the corresponding equipment ON time and/or the equipment OFF time.

The portfolio level equipment schedules are distributed from the multi-site BMS to one or more controllers 18, 22 at the remote sites 14, as indicated at block 34. The one or more controllers 18, 22 are configured to control operation of corresponding equipment 20, 24 at the remote sites 14 in accordance with the portfolio level equipment schedules, as indicated at block 36. In some cases, a site level user of a first remote site 14 is allowed to change a portfolio level equipment schedule and apply the changed portfolio level equipment schedule to one or more of the controllers 18, 22 of the first remote site 14, resulting in an changed portfolio level equipment schedule, as indicated at block 38. The one or more controllers 18, 22 at the first remote site 14 to which the changed portfolio level equipment schedule was applied control operation of corresponding equipment 20, 24 at the first remote site 14 in accordance with the changed portfolio level equipment schedule, as indicated at block 40. The portfolio level user is allowed to override the changed portfolio level equipment schedule at the first remote site 14 and return to the portfolio level equipment schedule, as indicated at block 42. In some cases, and as optionally indicated at block 44, an identifier may be provided on one or more screens of the multi-site BMS 12 that identifies to the portfolio level user that the site level user has changed the portfolio level equipment schedule.

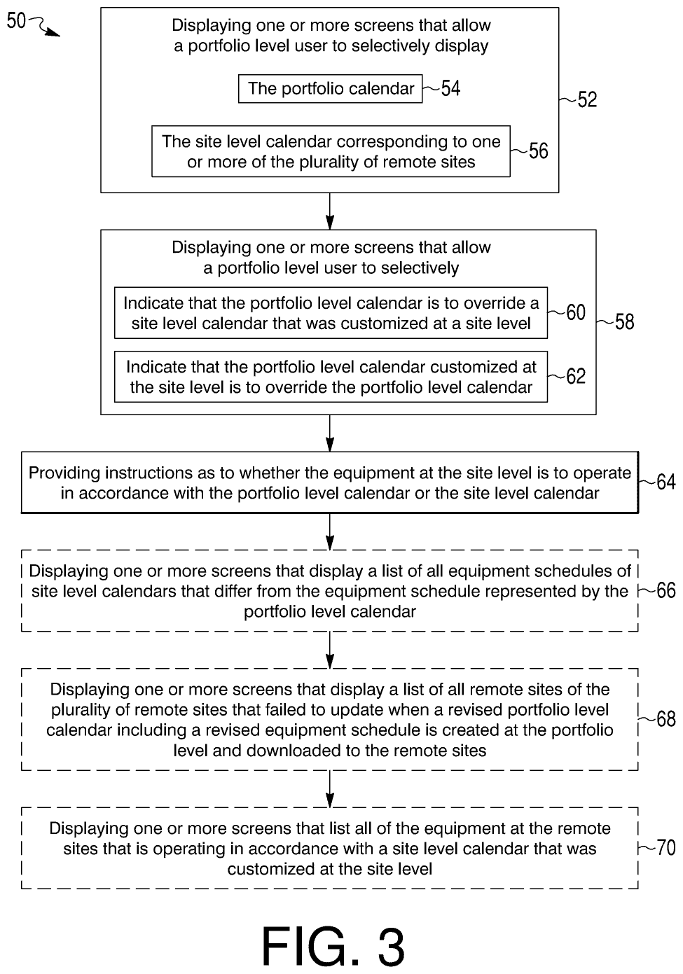

FIG. 3 is a flow diagram showing an illustrative method 50 of monitoring adherence with an equipment schedule for equipment distributed among a plurality of remote sites 14. A portfolio level calendar is created at a portfolio level that provides equipment schedules, and there is a site level calendar at each of the plurality of remote sites, the site level calendar at each of the plurality of remote sites 14 originally provided as a copy of the portfolio level calendar for that equipment. The portfolio level calendar may, for example, include scheduling information for local equipment that relies upon binary control or set point control. In some instances, the portfolio level calendar may include scheduling information for lighting equipment, HVAC equipment, security equipment and/or any other suitable building control equipment.

As indicated at block 52, one or more screens are displayed that allow a portfolio level user to selectively display the portfolio level calendar, as indicated at block 54 or the site level calendar corresponding to one or more of the plurality of remote sites, as indicated at block 56. As indicated at block 58, one or more screens are displayed that allow the portfolio level user to selectively indicate that the portfolio level calendar is to override a site level calendar that was customized at a site level, as indicated at block 60, or to indicate that the site level calendar customized at the site level is to override the portfolio level calendar, as indicated at block 62. Instructions are provided as to whether the equipment 20, 24 at the site level is to operate in accordance with the portfolio level calendar or the site level calendar, as indicated at block 64.

In some cases, and as optionally indicated at block 66, one or more screens may be displayed that display a list of all equipment schedules of site level calendars that differ from the equipment schedule represented by the portfolio level calendar. In some instances, and as optionally indicated at block 68, one or more screens may be displayed that display a list of all remote sites 14 of the plurality of remote sites 14 that failed to update when a revised portfolio level calendar including a revised equipment schedule is created at the portfolio level and downloaded to the remote sites. One or more screens may be displayed that list all of the equipment at the remote sites that is operating in accordance with a site level calendar that was customized at the site level, as optionally indicated at block 70.

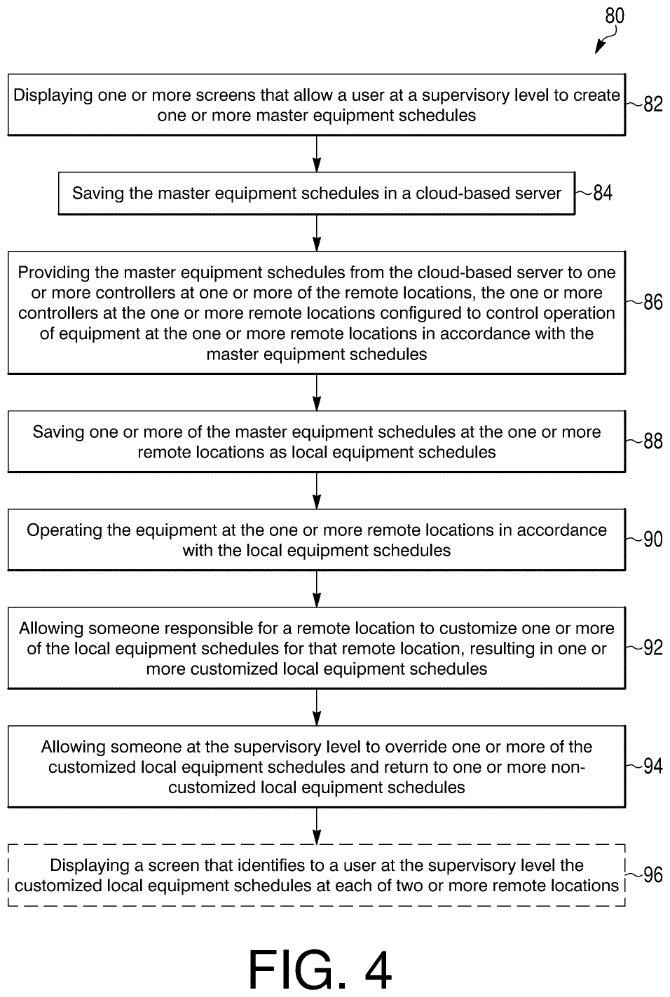

FIG. 4 is a flow diagram showing an illustrative method 80 of creating equipment schedules for equipment 20, 24 that is distributed at a plurality of remote locations. One or more screens are displayed that allow a user at a supervisory level to create one or more master equipment schedules, as indicated at block 82. The master equipment schedules are saved in a cloud-based server, as indicated at block 84. The master equipment schedules from the cloud-based server are provided to one or more controllers 18, 22 at one or more of the remote locations, the one or more controllers 18, 22 at the one or more remote locations configured to control operation of equipment 20, 24 at the one or more remote locations in accordance with the master equipment schedules, as indicated at block 86. The one or more of the master equipment schedules are saved at the one or more remote locations as local equipment schedules, as indicated at block 88.

The equipment 20, 24 at the one or more remote locations is operated in accordance with the local equipment schedules, as indicated at block 90. Someone responsible for a remote location is allowed to customize one or more of the local equipment schedules for that remote location, resulting in one or more customized local equipment schedules, as indicated at block 92. Someone at the supervisory level is allowed to override one or more of the customized local equipment schedules and return to one or more non-customized local equipment schedule, as indicated at block 94. In some cases, and as optionally indicated at block 96, a screen may be displayed that identifies to a user at the supervisory level the customized local equipment schedules at each of two or more of the remote locations.

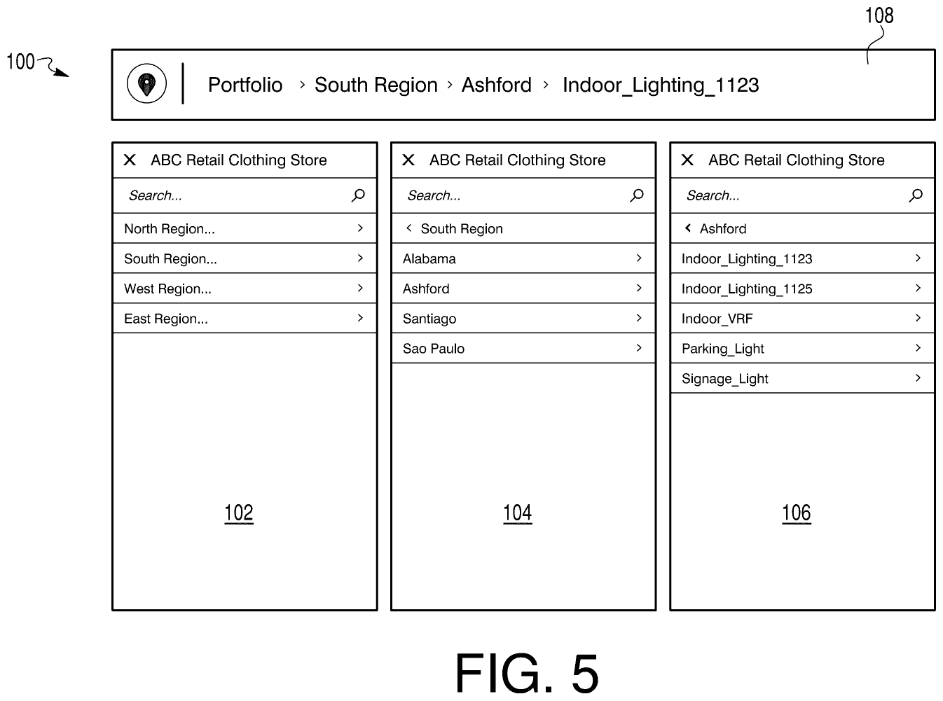

FIGS. 5 through 27 show illustrative screens of a multi-site BMS for creating and monitoring equipment schedules. FIG. 5 shows a screen 100 that illustrates how an organization hierarchy might translate into a calendar that provides an equipment schedule. The screen 100 includes a first panel 102 that shows geographic regions such as North Region, South Region, West Region and East Region for a company named ABC Retail Clothing Store. A second panel 104 shows what might be displayed if someone selects the South Region in the first panel 102. The second panel 104 shows individual locations within the South Region, such as Alabama, Ashford, Santiago and San Paulo. The screen 100 includes a third panel 106 that shows what might be displayed if someone selects Ashford in the second panel 104. The third panel 106 displays options such as indoor lighting sections, indoor VRF (variable refrigerant flow units), parking lights and signage lights. The screen 100 includes a banner 108 that shows this hierarchical relationship in a bread crumb format, starting with the portfolio level.

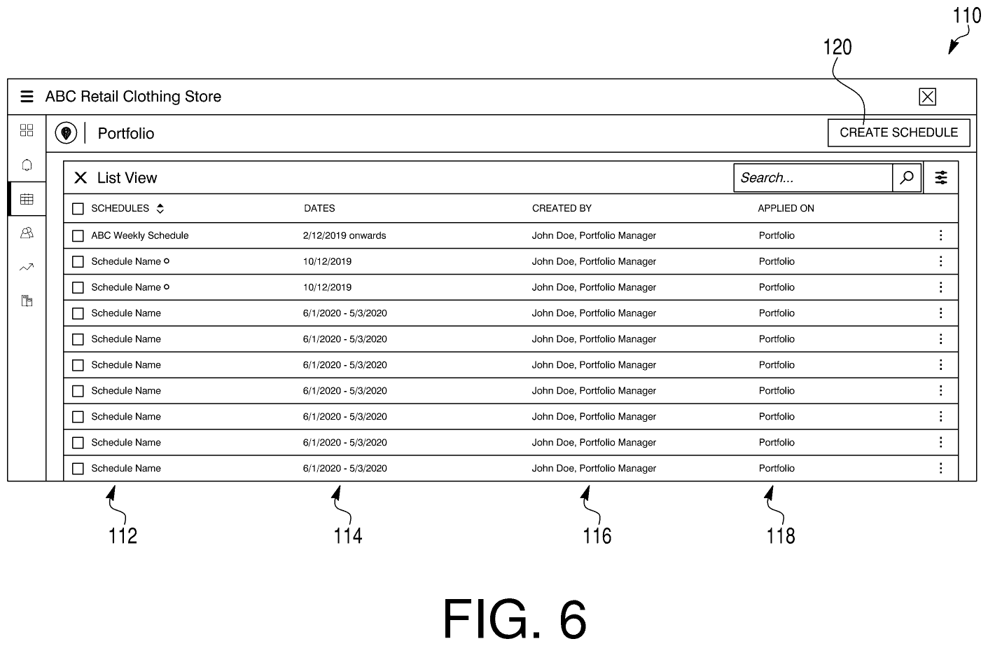

FIG. 6 shows a screen 110 that illustrates a list view of a portfolio-level equipment schedule. The screen 110 includes a list of schedule names 112, a list of effective dates 114, a list of who created the schedules 116 and a list of how the schedules were applied 118. It will be appreciated that the screen 110 includes a Create Schedule button 120 that may be used to create a new equipment schedule, for example.

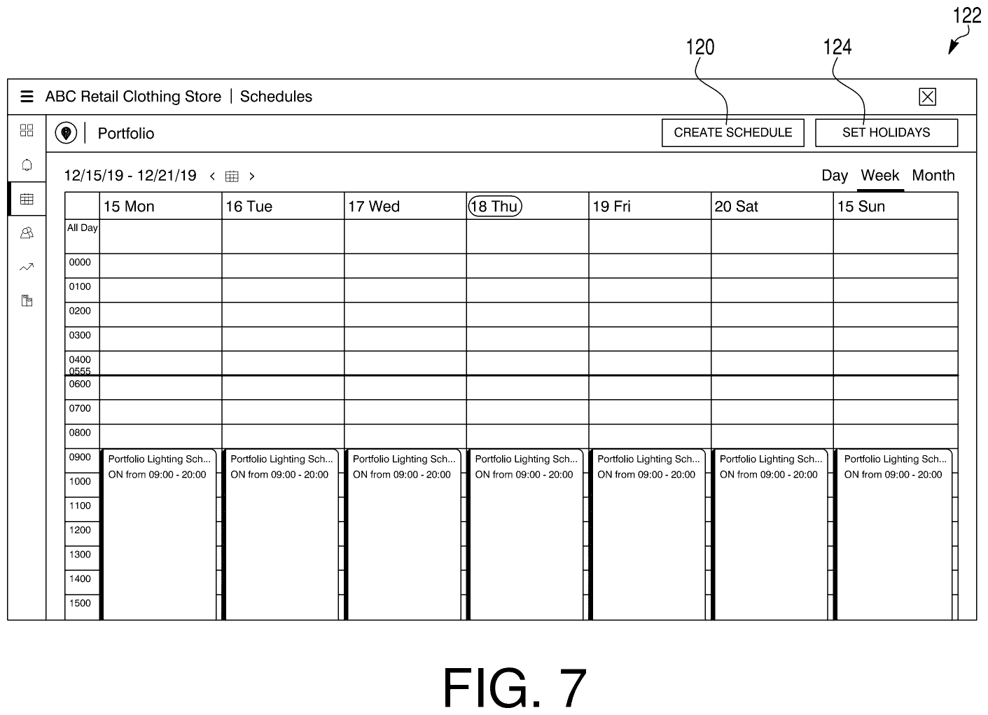

FIG. 7 shows a screen 122 that once again includes a Create Schedule button 120, but also includes a Set Holidays button 124. The screen 122 provides an example of a portfolio-level calendar view of an equipment schedule. In the example given, the screen 122 shows a weekly portfolio lighting schedule for ABC Retail Clothing Stores. In this equipment schedule, lighting is scheduled to be on every day Monday through Sunday, from 9 am (shown as 0900 hours) to 8 pm (shown as 2000 hours). It will be appreciated that only a portion of the screen 122 is visible. One may scroll vertically to see the rest of the calendar.

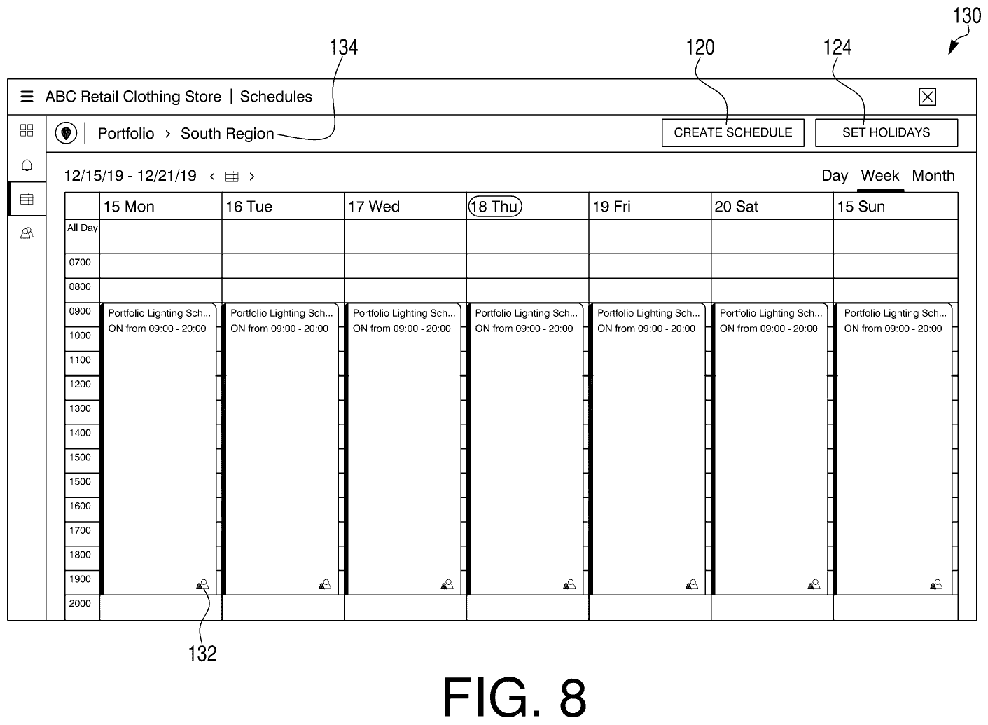

FIG. 8 shows a screen 130 that includes both the Create Schedule button 120 and the Set Holidays button 124. The screen 130 shows a weekly portfolio-level calendar schedule (same as shown in FIG. 7), but the screen 130 includes an icon 132 on each day of the week that indicates that the South Region is running in accordance with the portfolio-level calendar schedule that was received by the South Region. The screen 130 includes an indicator 134 showing that the displayed calendar pertains to the South Region.

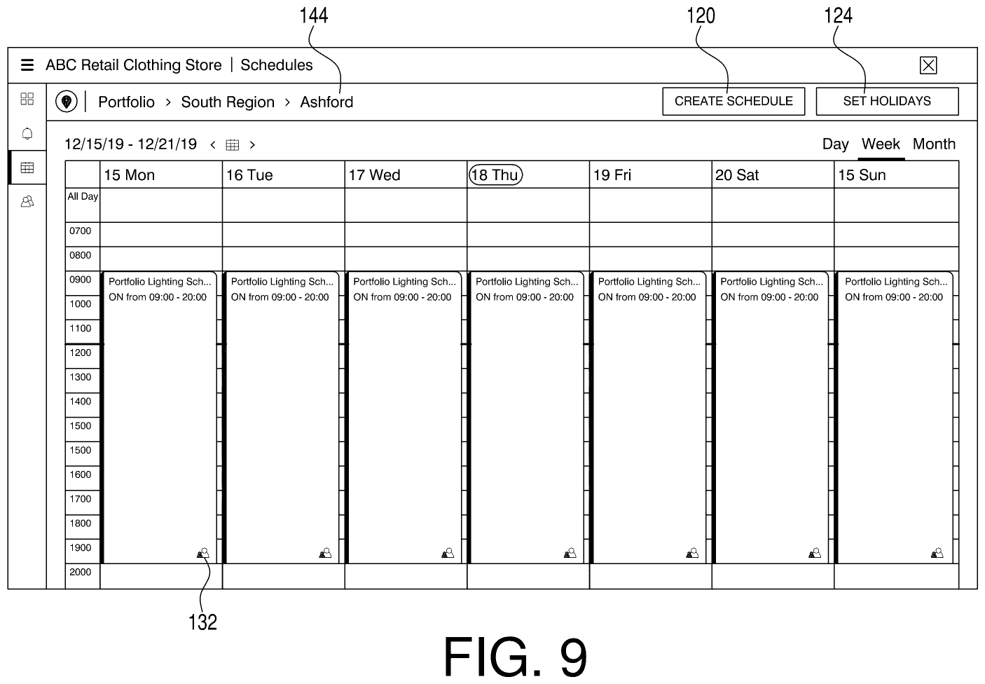

FIG. 9 shows a screen 140 that includes both the Create Schedule button 120 and the Set Holidays button 124. The screen 140 shows a weekly portfolio-level calendar schedule (same as shown in FIG. 7), but the screen 140 includes an icon 132 on each day of the week that indicates that the Ashford location is running in accordance with the portfolio-level calendar schedule that was received by the Ashford. The screen 140 includes an indicator 144 showing that the displayed calendar pertains to the Ashford location.

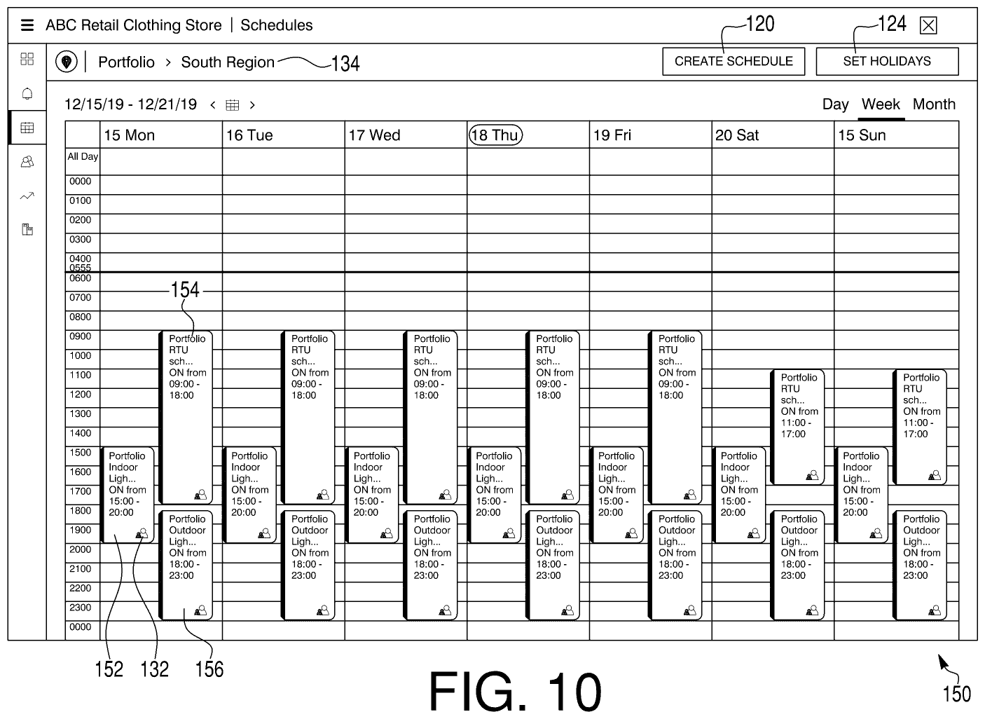

FIG. 10 shows a screen 150 that includes both the Create Schedule button 120 and the Set Holidays button 124. As evidenced by the indicator 134, the screen 150 pertains to the South Region but includes multiple schedules. As can be seen, the screen 150 shows a portfolio-level indoor lighting schedule 152 that runs Monday through Sunday and specifies operation of the indoor lighting every day from 3 pm (1300 hours) to 8 pm (2000 hours). The screen 150 also shows a portfolio-level RTU (roof top unit) schedule 154 that runs Monday through Friday from 9 am (0900 hours) to 6 pm (1800 hours) and runs Saturday through Sunday from 11 am (1100 hours) to 5 pm (1700 hours). The screen 150 also shows a portfolio-level outdoor lighting schedule 156 that runs Monday through Sunday from 6 pm (1800 hours) to 11 pm (2300 hours). Each of the schedules 152, 154 and 156 can be seen to include the icon 132 that indicates that the South Region is operating in accordance with each of the portfolio-level schedules.

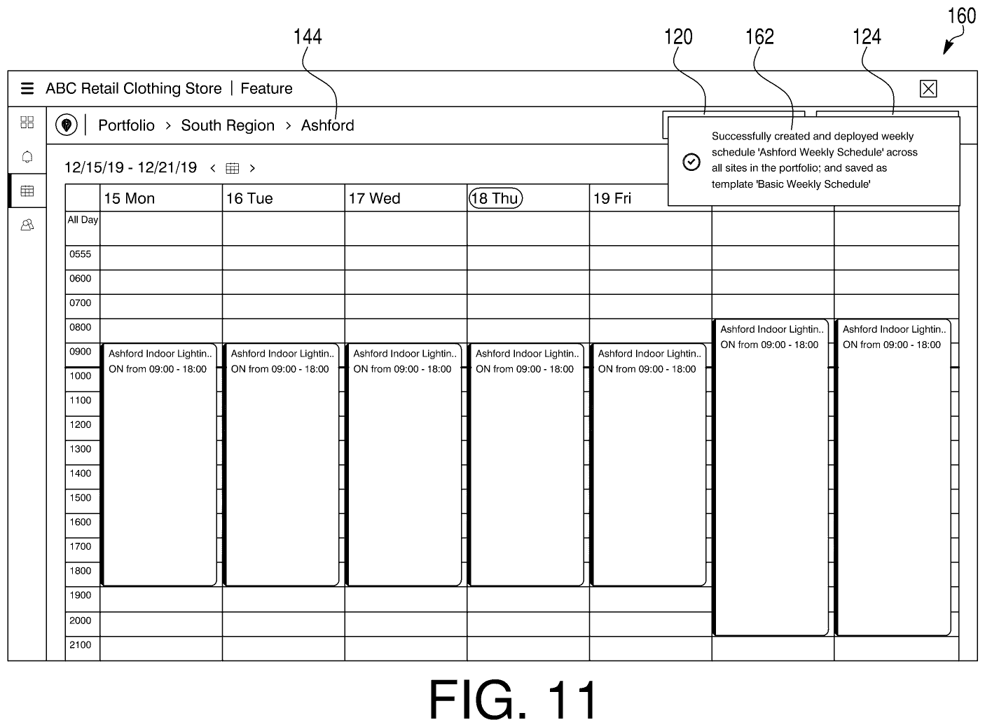

FIG. 11 shows a screen 160 that includes a child calendar created locally for the Ashford location, as seen by the indicator 144. The screen 160 includes a message 162 saying that the schedule was successfully created and deployed at the Ashford location. The screen 160 shows a local indoor lighting schedule that replaces the portfolio-level indoor lighting schedule. The new customized indoor lighting schedule for the Ashford location runs Monday through Friday from 9 am (0900 hours) to 6 pm (1800 hours) and runs Saturday through Sunday from 8 am (0800 hours) to 11 pm (2300 hours). The icon 132 is not shown on this customized schedule, which is a visual queue to the portfolio level user that the schedule is not the portfolio-level calendar schedule.

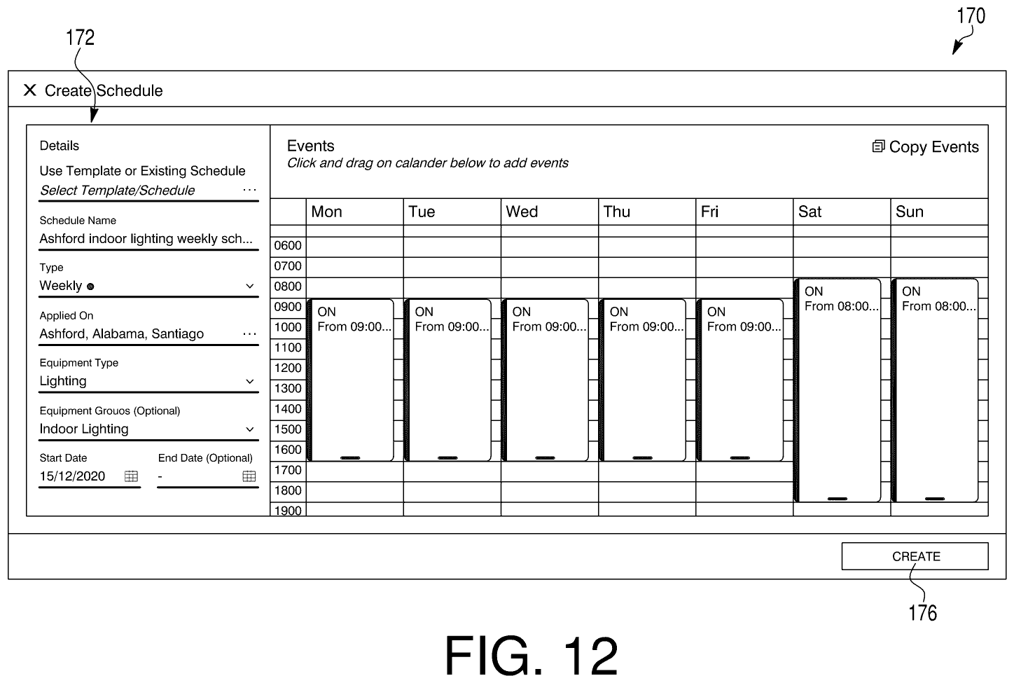

FIG. 12 shows a screen 170 that may be used to create a schedule calendar. The screen 170 includes a details panel 172 that includes various details for the calendar as well as a calendar panel 174 in which a user can set the equipment On and equipment OFF times for whatever equipment schedule is being created. As seen in the details panel 172, the schedule being created is an indoor lighting schedule to be used by several locations in the South Region. As seen in the calendar panel 174, the schedule being created runs Monday through Friday from 9 am (0900 hours) to 6:30 pm (1830 hours) and runs Saturday through Sunday from 8 am (0800 hours) to 8:30 pm (2030 hours). The screen 170 includes a Create button 176 that can be used to save and implement the proposed schedule as shown in the calendar panel 174.

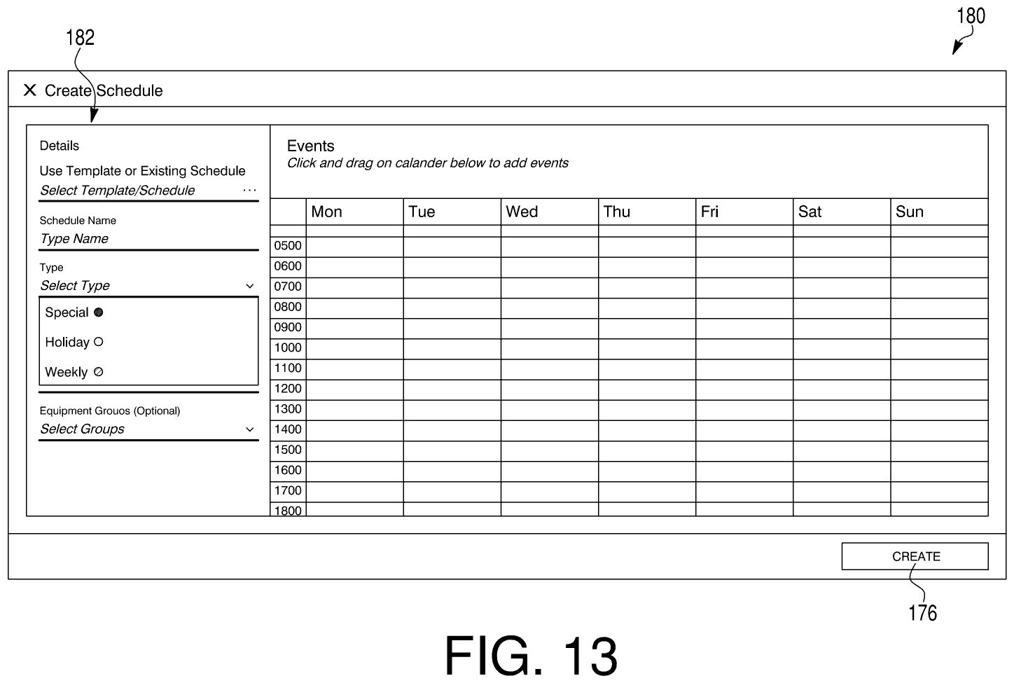

FIG. 13 shows a screen 180 that may be used to create a schedule calendar. The screen 180 includes a details panel 182 that shows the different types of calendars that can be created. As seen in the details panel 182, a user can create a special event calendar, a holiday calendar or a weekly calendar. In some cases, a different color or pattern may be used as the calendar marker that shows the daily equipment start and stop times. As an illustrative but non-limiting example, the calendar markers may be purple for a weekly calendar, orange for a holiday calendar and blue for a special calendar. It will be appreciated that a myriad of other colors and/or patterns may be used to indicate the type of calendar being displayed.

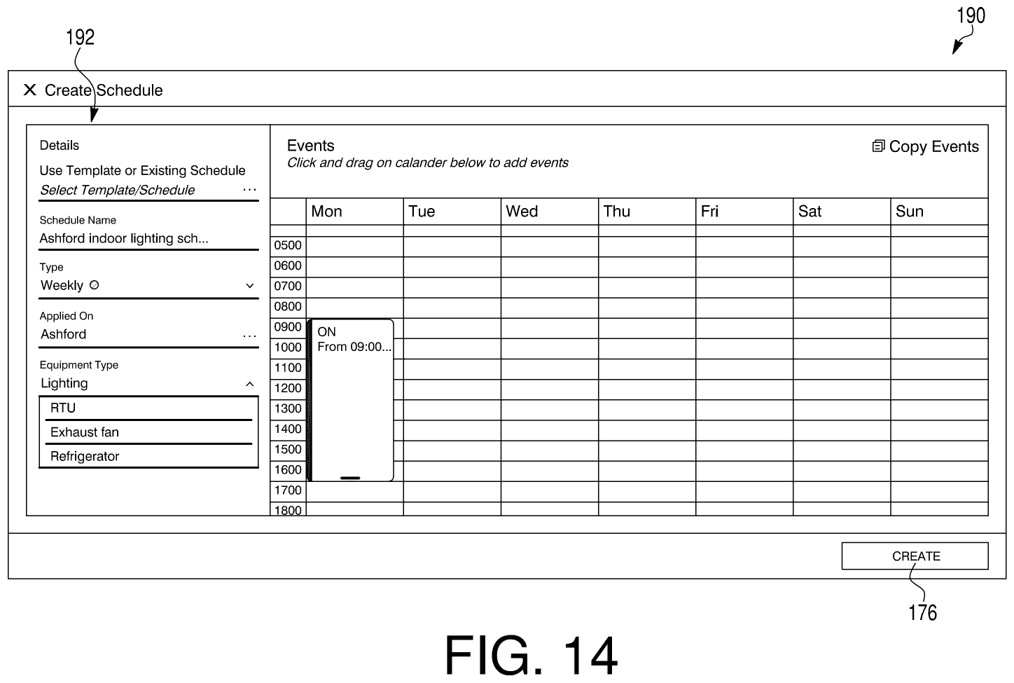

FIG. 14 shows a screen 190 that may be used to create a schedule calendar. The screen 190 includes a details panel 192 that shows all of the supported types of equipment. It is contemplated, of course, that additional types of equipment may be supported as well. As seen in the details panel 192, supported types of equipment may include lighting, RTU (roof top units), exhaust fans and refrigerators. Additional types of supported equipment may be specified by scrolling down if appropriate.

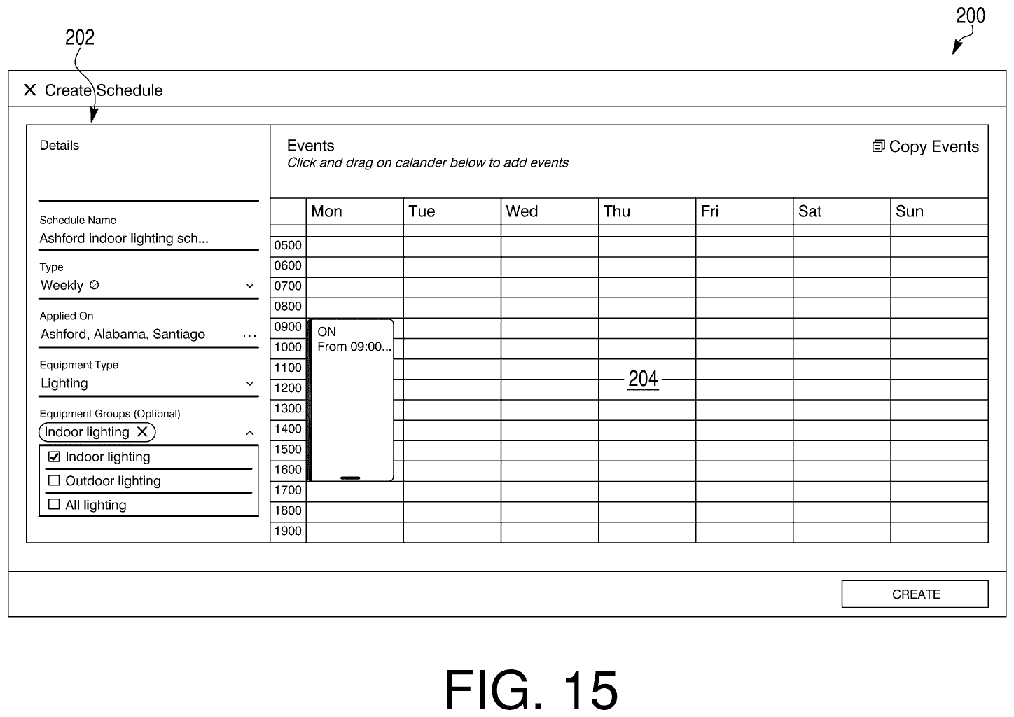

FIG. 15 shows a screen 200 that may be used to create a schedule calendar. The screen 200 includes a details panel 202 and a calendar panel 204. The details panel 202 includes a listing of all the possible groups of equipment. In the given example, the details panel 202 shows the different groups of lighting. It will be appreciated that the groups of equipment that are shown will depend on what is selected in the screen 190 (FIG. 14). In some cases, these groups may be user-configurable. As seen in the calendar panel 204, the person creating the schedule may not be done, as they are creating a weekly schedule but only have one day filled in thus far.

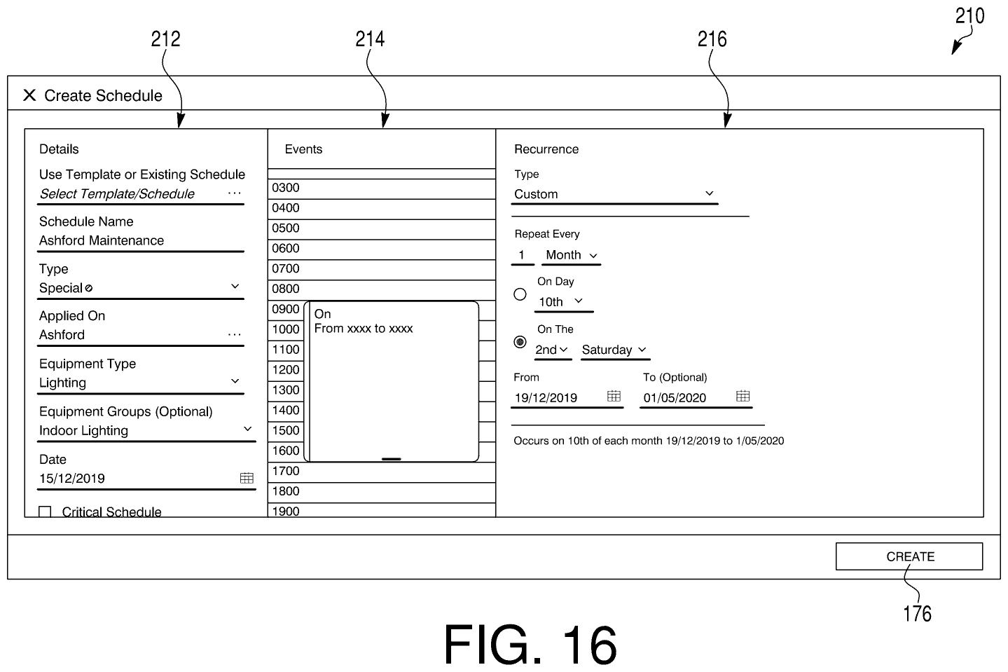

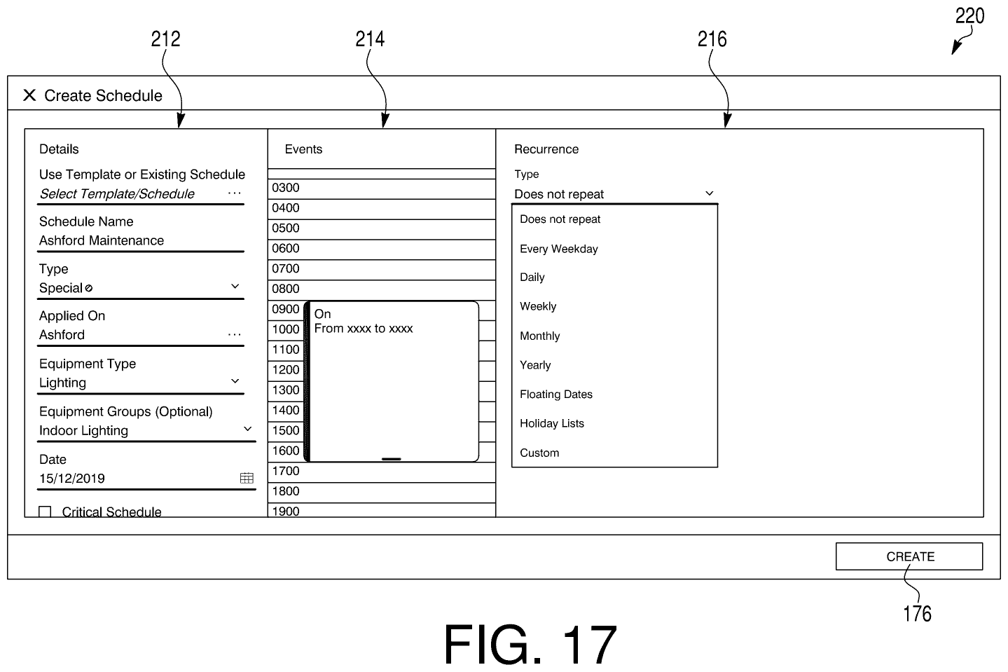

FIG. 16 shows a screen 210 that may be used to create a special events calendar. The screen 210 includes a details panel 212, an events panel 214 and a recurrence panel 216. As seen in the details panel 212, a special event indoor lighting calendar is being created. As seen in the events panel 214, the lighting will be on from 9 am (0900 hours) to 6:30 pm (1830 hours). As seen in the recurrence panel 216, this special event will occur on the second Saturday of the month. FIG. 17 provides a screen 220 that is similar to the screen 210, but provides other options within the recurrence panel 216. In this case, the special event is designated as a one-time event, and thus does not repeat.

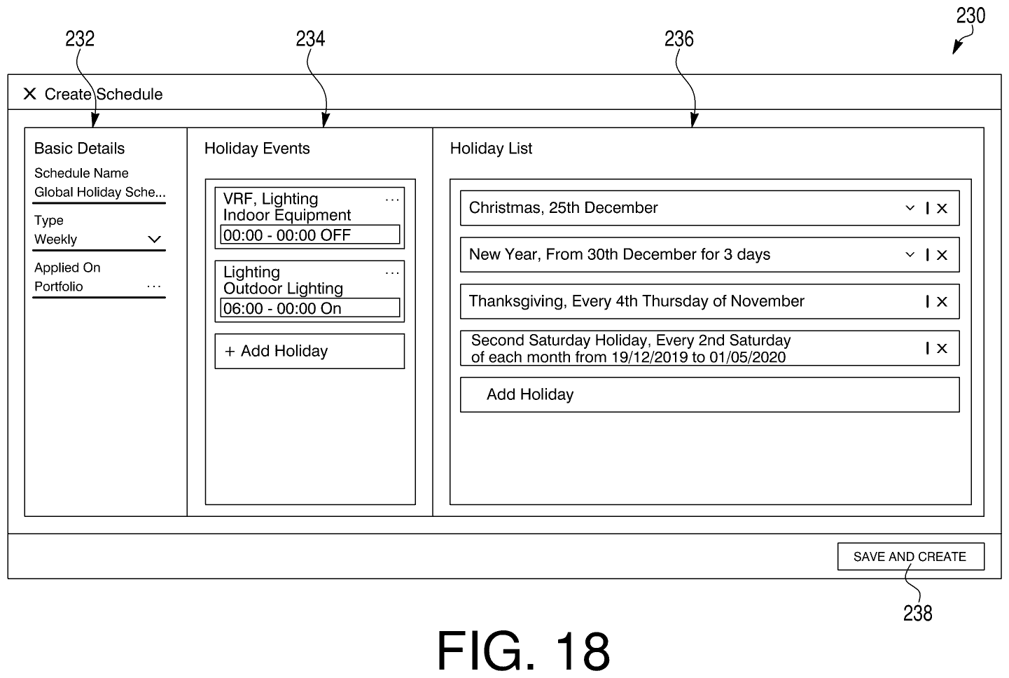

FIG. 18 shows a screen 230 that may be used to create a holiday calendar. The screen 230 includes a Basic Details panel 232, a Holiday Events panel 234 and a Holiday List panel 236. The Basic Details panel 232 provides information regarding the name of the schedule, what type of calendar it is and what level it will be applied at. In the example given, a global holiday weekly calendar at the portfolio level is being created. The Holiday Events panel 234 shows the type of equipment that will be included while the Holiday List panel 236 includes a list of possible holidays and their usual duration. The user is able to select a holiday from the list or is able to delete a holiday from the list. The user is also able to create a new holiday. The screen 230 includes a Save and Create button 238.

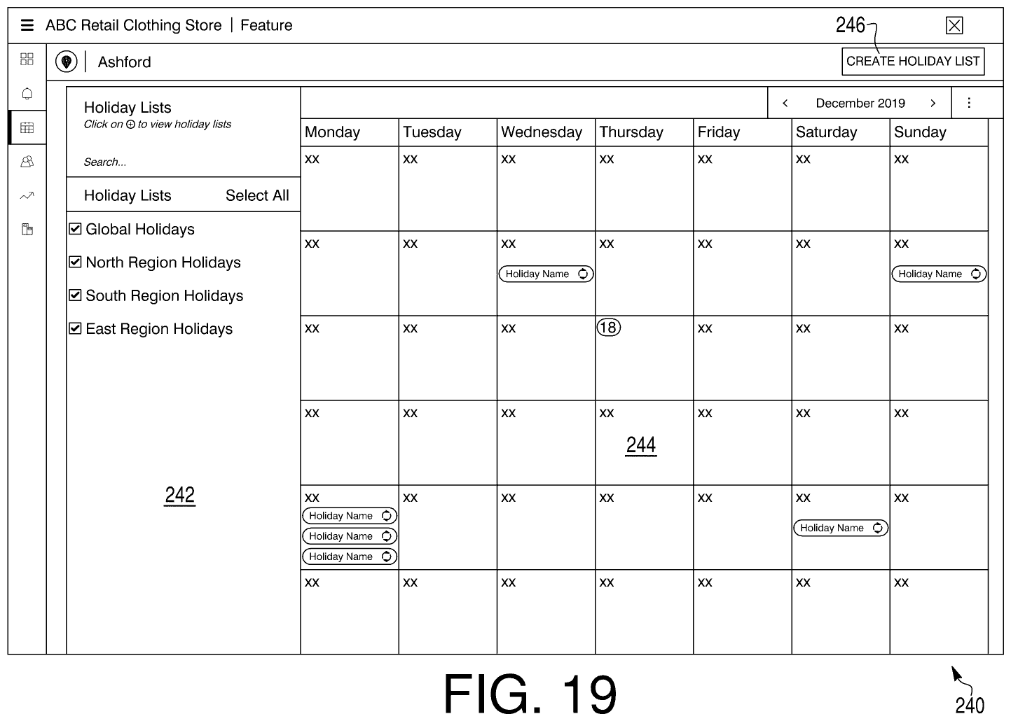

FIG. 19 shows a screen 240 that provides a calendar view, rather than a list view, for creating holiday schedules. The screen 240 includes a panel 242 that shows a legend for the holiday schedules being displayed within a calendar panel 244. As indicated in the legend, the screen 240 includes global holidays, North Region holidays, South Region holidays and East Region holidays. The screen 240 includes a Create Holiday List button 246, which may be used to revert to the screen 230, for example.

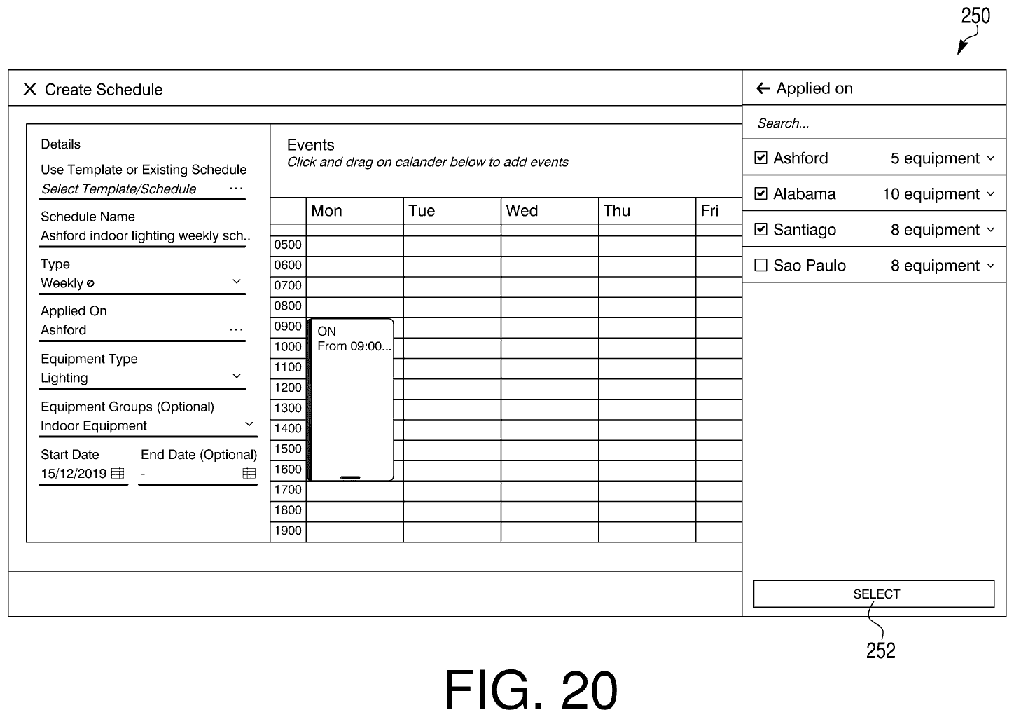

FIG. 20 shows a screen 250 that illustrates how a calendar may be created and then copied to create additional schedules. The screen 250 includes a parent schedule portion 252 and a child schedule portion 254. The parent schedule portion 252 shows a weekly indoor lighting schedule for Ashford, which is being copied over to, as indicated by the child schedule portion 254, Alabama and Santiago (several other locations in the South Region). The screen 250 includes a Select button 252.

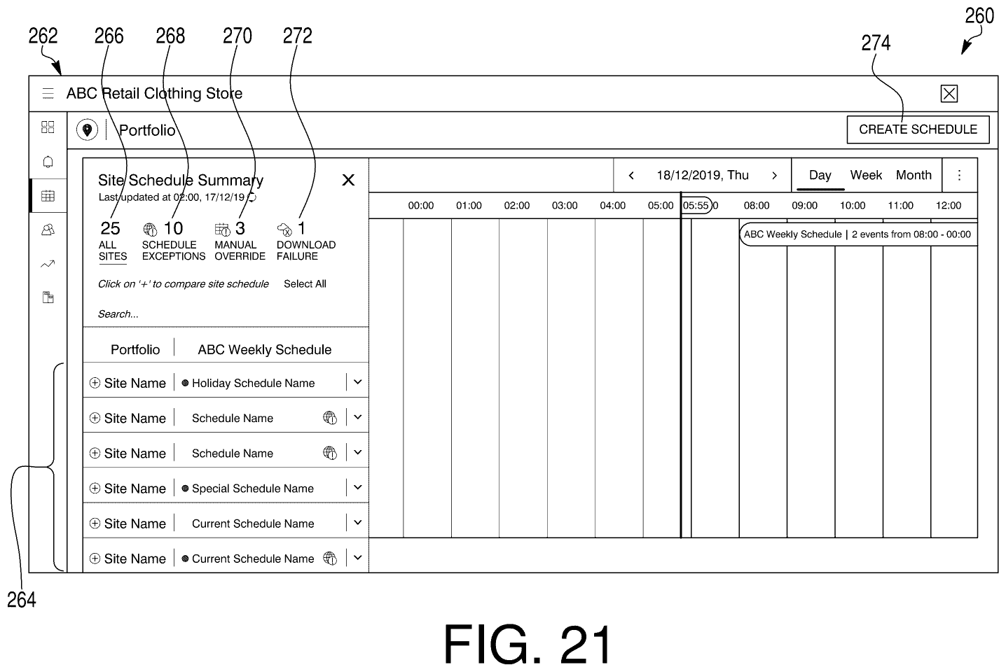

FIG. 21 shows a screen 260 that provides a schedule summary that allows a user to track the status of particular schedules by its children calendars. For a specific schedule, a complete report may be generated that includes a (1) list of all of the child calendars that were supposed to inherit this schedule but are instead following a local schedule, (2) a list of all controllers or gateways that failed to download, and (3) a list of all equipment that is running on manual override (e.g. no schedule). The screen 260 includes a site schedule summary 262 that provides an icon 266 that is a total number of sites as well as totals for each of (1), (2) and (3) under an icon 268, an icon 270 and an icon 272, respectively. The screen 260 also includes a list 264 that shows all of the sites, as evidenced by the icon 266 being highlighted (e.g. underlined).

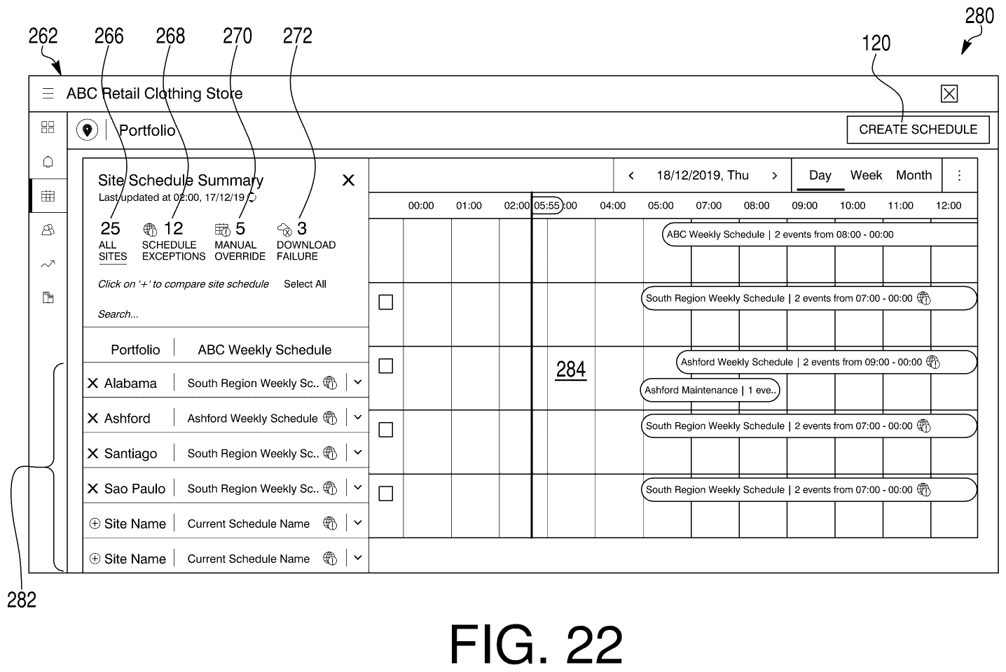

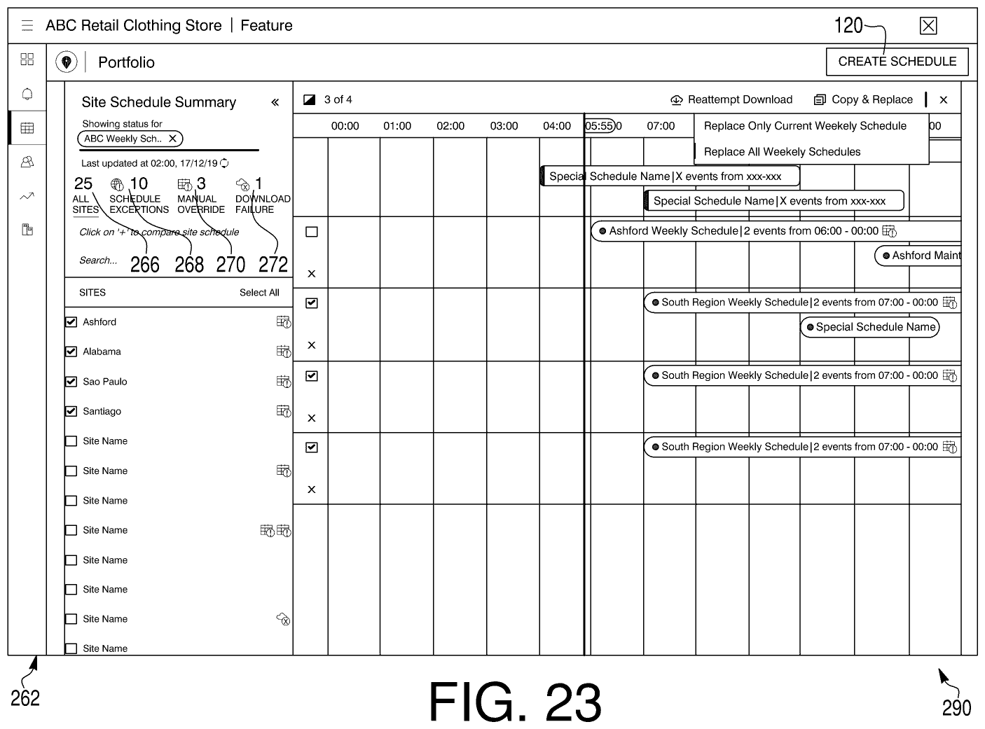

FIG. 22 shows a screen 280 that is similar to the screen 260 shown in FIG. 21, but instead provides a listing of schedule exceptions. It can be seen that the icon 268, for Schedule Exceptions, is highlighted (e.g. underlined). The screen 280 includes a list 282 of schedule exceptions and a panel 284 that graphically illustrates each of the schedule exceptions. Several actions can be taken. One option is a Resolve Exception, which involves overwriting the child calendars with the schedules on parent calendars (e.g. portfolio level equipment schedules) against which the child calendars (e.g. local equipment schedules) are being compared. For gateways and controllers for which a download failed, the user can retry the download. In some cases, a supervisor may decide to dynamically turn off a manual override and instead revert operation to a regular schedule. FIG. 23 shows a screen 290 that may be used in resolving schedule conflicts.

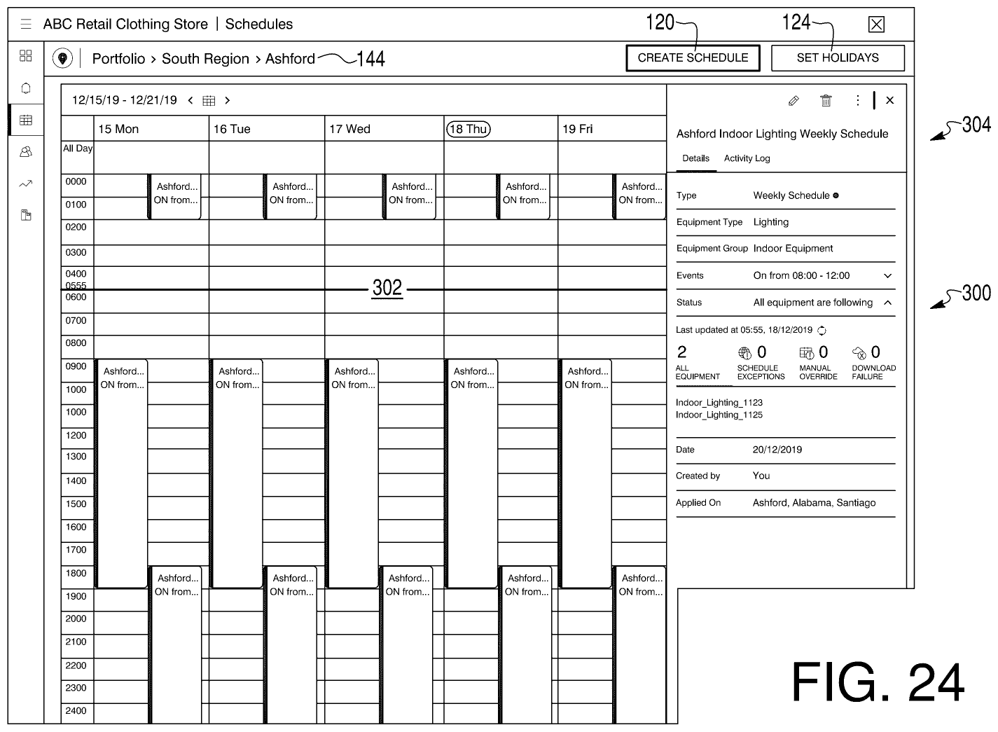

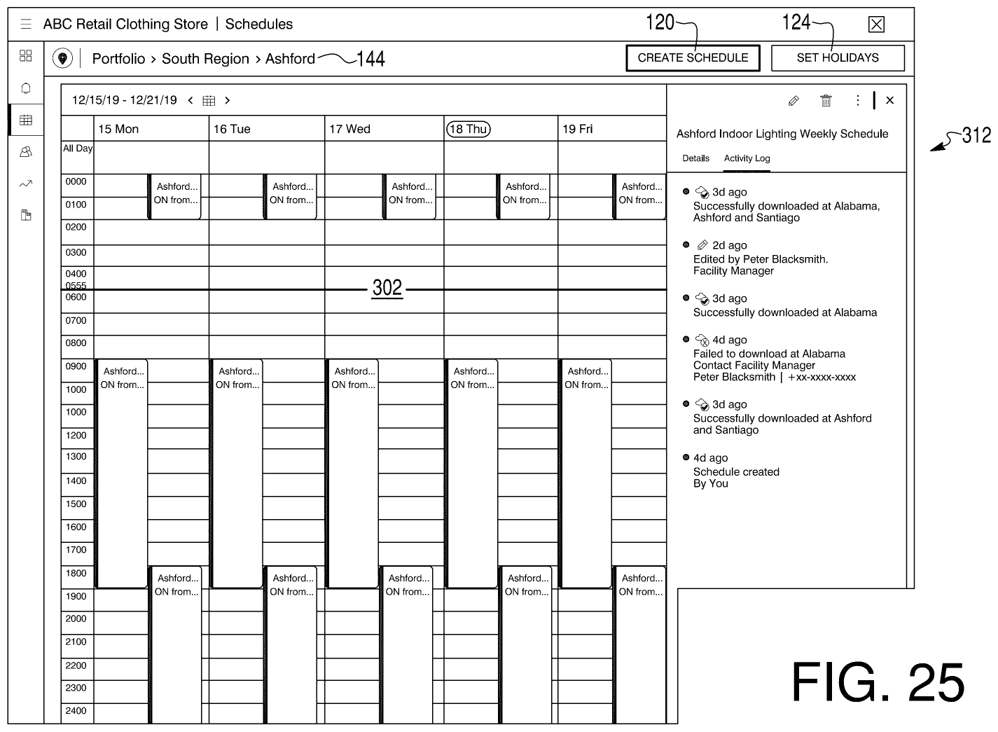

FIG. 24 provides a screen 300 that shows a schedule for the Ashford location, as seen by the indicator 144. The screen 300 includes a schedule panel 302 that graphically illustrates the schedule, as well as a details panel 304 that provides a quick summary regarding exceptions, download failures and the like. FIG. 25 shows a screen 310 that includes the schedule panel 302 and an activity log 312.

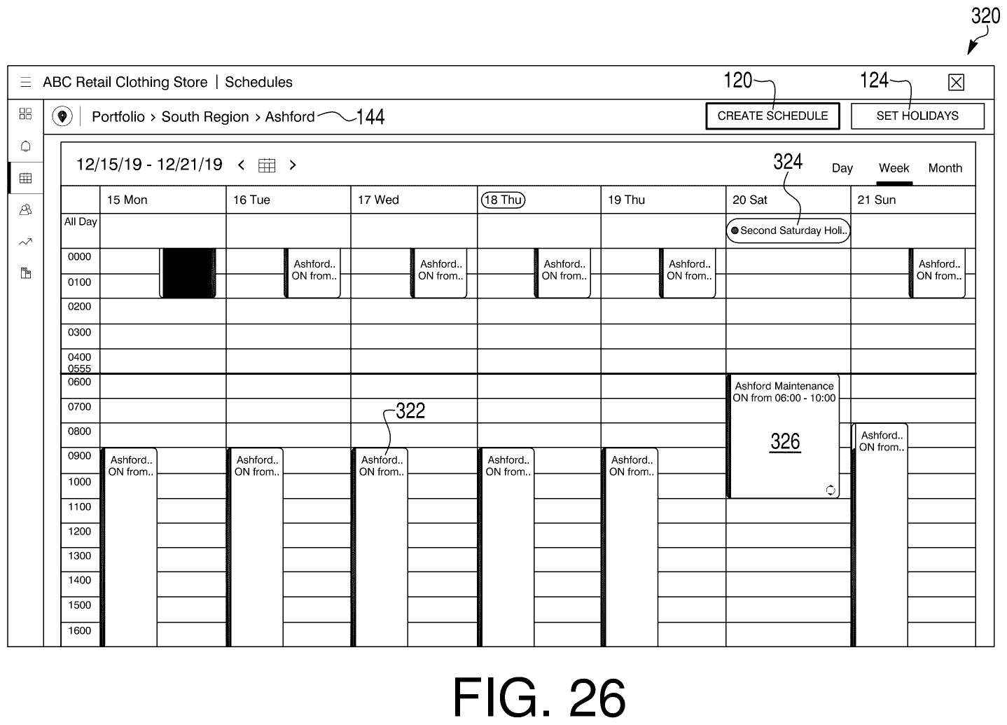

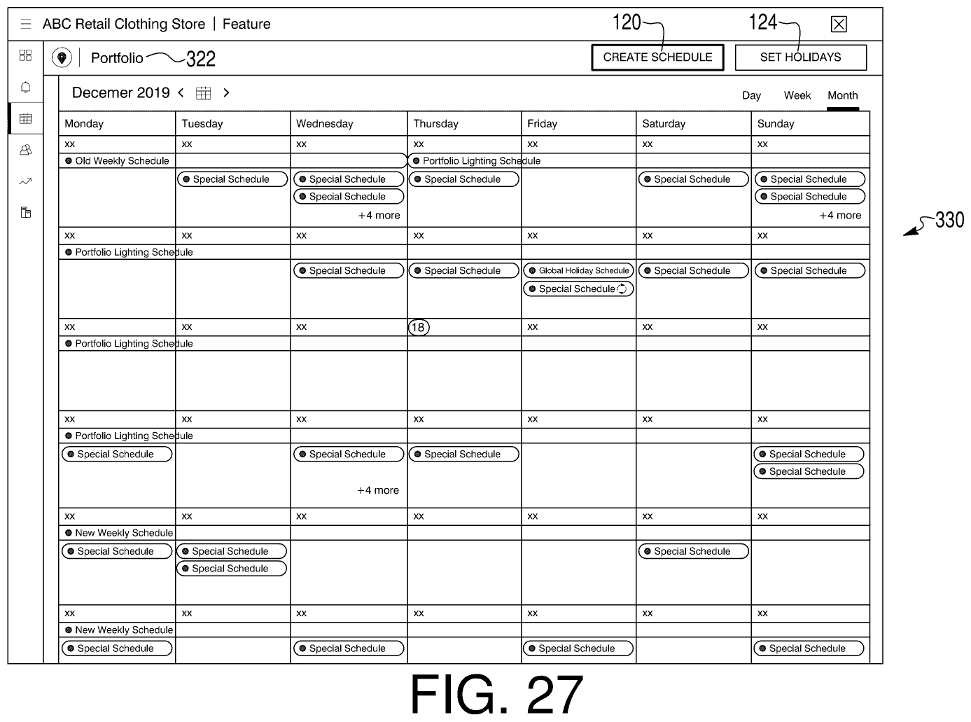

FIG. 26 provides a screen 320 that shows a schedule for the Ashford region that includes all types of schedules. As shown, the screen 320 includes a weekly schedule 322, a holiday schedule 324 and a special events schedule 326. FIG. 27 provides a screen 330 that provides a monthly view of all schedules at a portfolio level, as seen by an indicator 332. Any of the schedules shown can be clicked on to obtain additional detail.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A cloud-based server, comprising:
a memory storing one or more portfolio level equipment schedules for use in controlling building control equipment at one or more remote sites;
a controller operatively coupled to the memory, the controller configured to:
transmit each of one or more of the portfolio level equipment schedules across a network for reception by one or more remote sites;
automatically identify which of the portfolio level equipment schedules that have been transmitted across the network have been customized at the one or more remote sites, resulting in one or more customized portfolio level equipment schedules, and that are currently being used in controlling building control equipment at the corresponding remote site; and
transmit one or more commands for reception by one or more remote sites to override one or more of the customized portfolio level equipment schedules that are currently being used in controlling building control equipment at the corresponding remote site and return to the corresponding non-customized portfolio level equipment schedule.

2. The cloud-based server of claim 1, wherein the controller is configured to:
identify which if any of the transmitted portfolio level equipment schedules failed to be successfully received by the one or more remote sites; and
re-transmit the portfolio level equipment schedules that are identified as having failed to be successfully received by the one or more remote sites.

3. The cloud-based server of claim 1, wherein each of the one or more remote sites includes a gateway operatively coupled to the network for receiving one or more of the portfolio level equipment schedules transmitted by the controller.

4. The cloud-based server of claim 3, wherein each of the one or more remote sites includes one or more controllers operatively coupled to the gateway of the corresponding remote site, wherein each controller is configured to control building control equipment at the corresponding remote site based at least in part on one or more currently active equipment schedules, wherein the one or more currently active equipment schedules correspond to one or more of the portfolio level equipment schedules or one or more of the customized portfolio level equipment schedules.

5. The cloud-based server of claim 1, wherein the controller is configured to:
display on a display one or more visual cues that visually indicate which of the portfolio level equipment schedules have been determined to be customized at the one or more remote sites.

6. The cloud-based server of claim 1, wherein the building control equipment at one or more of the remote sites comprises indoor lighting equipment and/or outdoor lighting equipment.

7. The cloud-based server of claim 1, wherein the building control equipment at one or more of the remote sites comprises heating, ventilating and air conditioning (HVAC) equipment.

8. The cloud-based server of claim 1, wherein the building control equipment at one or more of the remote sites comprises security equipment.

9. The cloud-based server of claim 1, wherein at least one of the one or more portfolio level equipment schedules comprises a weekly schedule.

10. The cloud-based server of claim 1, wherein at least one of the one or more portfolio level equipment schedules comprises a holiday schedule and/or a special event schedule.

11. A remote site, comprising:
a gateway for communicating with a remote server;
a Building Management System (BMS) operatively coupled to the gateway, the BMS including:
building control equipment;
a memory;
a controller operatively coupled to the building control equipment, the memory and the gateway, the controller configured to:
receive one or more portfolio level equipment schedules from the remote server via the gateway;
store the one or more portfolio level equipment schedules in the memory;
store one or more customized portfolio level equipment schedules in the memory, wherein each of the one or more customized portfolio level equipment schedules are customized from a corresponding one of the one or more portfolio level equipment schedules received from the remote server;
control the building control equipment based at least in part on one or more of the customized portfolio level equipment schedules;
receive from the remote server via the gateway one or more commands to override each of one or more of the customized portfolio level equipment schedules that are currently being used in controlling the building control equipment with the corresponding one of the one or more non-customized portfolio level equipment schedule; and
control the building control equipment based at least in part on the corresponding one of the one or more non-customized portfolio level equipment schedules.

12. The remote site of claim 11, wherein the controller is configured to:
report to the remote server via the gateway which of the portfolio level equipment schedules have been customized resulting in the one or more customized portfolio level equipment schedules.

13. The remote site of claim 11, wherein the controller is configured to:
report to the remote server via the gateway a successfully reception of each of the one or more portfolio level equipment schedules.

14. The remote site of claim 11, wherein the building control equipment comprises indoor lighting equipment and/or outdoor lighting equipment.

15. The remote site of claim 11, wherein the building control equipment comprises heating, ventilating and air conditioning (HVAC) equipment.

16. The remote site of claim 11, wherein the building control equipment comprises security equipment.

17. The remote site of claim 11, wherein at least one of the one or more portfolio level equipment schedules comprises a weekly schedule.

18. The remote site of claim 11, wherein at least one of the one or more portfolio level equipment schedules comprises a holiday schedule and/or a special event schedule.

19. A building control system, comprising:
a server, including:
a server memory storing one or more portfolio level equipment schedules for use in controlling building control equipment at a remote site;
a server controller operatively coupled to the server memory, the server controller configured to:
transmit each of one or more of the portfolio level equipment schedules to the remote site;
automatically identify which of the portfolio level equipment schedules that have been transmitted to the remote site have been customized at the remote site, resulting in one or more customized portfolio level equipment schedules, and are currently being used in controlling building control equipment at the remote site;
transmit one or more commands for reception by the remote site to override one or more of the customized portfolio level equipment schedules that are currently being used in controlling building control equipment at the remote site and return to the corresponding non-customized portfolio level equipment schedule;
the remote site, including:
a gateway for communicating with the server;
a Building Management System (BMS) operatively coupled to the gateway, the BMS including:
the building control equipment;
a BMS memory;
a BMS controller operatively coupled to the building control equipment, the BMS memory and the gateway, the BMS controller configured to:
receive the one or more portfolio level equipment schedules from the remote server via the gateway;
store the one or more portfolio level equipment schedules in the BMS memory;
store the one or more customized portfolio level equipment schedules in the BMS memory;
control the building control equipment based at least in part on one or more of the customized portfolio level equipment schedules;
receive via the gateway the one or more commands transmitted by the server to override each of one or more of the customized portfolio level equipment schedules that are currently being used in controlling the building control equipment with the corresponding non-customized portfolio level equipment schedule; and
control the building control equipment based at least in part on the corresponding one of the one or more non-customized portfolio level equipment schedules.

20. The building control system of claim 19, wherein the server controller is configured to:
identify which if any of the transmitted portfolio level equipment schedules failed to be successfully received by the remote site; and
re-transmit the portfolio level equipment schedules that are identified as having failed to be successfully received by the remote site.
